(19) United States
(12) Patent Application Publication
(10) Pub. No.: US 2024/0232978 A1
(43) Pub. Date: Jul. 11, 2024

(54) KIT FOR ASSISTING WITH ONLINE PURCHASES AND RELATIVE USE METHOD

(71) Applicant: VEDOMARKET S.R.L., Roma (RM) (IT)

(72) Inventors: Emanuele CARIELLO, Roma (RM) (IT); Giovanni Battista NONNI, ROMA (RM) (IT)

(21) Appl. No.: 18/264,169

(22) PCT Filed: Mar. 1, 2022
(86) PCT No.: PCT/IB2022/051774

§ 371 Date: Aug. 3, 2023

(30) Foreign Application Priority Data
Mar. 10, 2021 (IT) 102021000005567

(51) Int. Cl. G06Q 30/0601

(52) U.S. Cl. CPC G06Q 30/0631; G06Q 30/0633

(57) ABSTRACT

Kit for assisting with online purchases, adapted to ensure the display of the products that the client intends to purchase online, by a video connection established between the operator and the client; the kit including: at least a dynamic visor that allows the display of all the information relative to the preceding selections of the client; at least a video camera, to share with the client all that the operator observes during the online purchase steps; at least an audio headphone; at least a microphone; at least a portable battery, placed within a common container, at least a CPU, installed within a container which allows the wearability thereof on the operator, adapted to receive all the input and output data of the present kit, establishing the communication between the operator and the client interested in purchasing by a common Wi-Fi internet connection; a plurality of cables.

### FIELD OF THE ART

The invention refers to the field of online purchases, in particular to the difficulty that is encountered in selecting products without actually observing them in person. The object of the invention is to provide to the client the information necessary for making an informed selection, without surprises.

### PRIOR ART

In the course of recent months, since the pandemic blocked the worldwide population, limiting the travel thereof, online purchases have for many been the only method of supply, even of primary commodities such as “fresh” foods (fruits and vegetables, gastronomy products, sausages, meat, etc.).

Unlike the packaged/canned/bottled products, usually brand names and therefore easily identifiable and purchasable from a static catalogue, “fresh” products require another type of evaluation for the selection. This is a “physical” evaluation, in particular visual, olfactory and tactile, evidently impossible to do by looking at an image, which can only recall the type, the name of the product, but not its actual appearance.

It is evident that such limitation can divert purchases, as consumers renounce “fresh” products, facilitating for example the consumption of frozen foods (canned and recognizable), or it creates disappointment and discontent for the consumer who—since all he/she could do is have faith that a satisfactory product would arrive—would in reality see products arrive that he/she would have never purchased, had he/she been able to see them first.

The limitation of the static photographic catalogue also removes the pleasure that a consumer would have in being attracted by a product only for the fact of seeing it on a shelf or being induced to purchase from the appearance that the product itself offers, which inspires the consumer to believe the products are of good quality.

Therefore, online sales, with the modes and the platforms that are presently in use, often cause the client to be dissatisfied, since he/she had to settle with purchasing “with his/her eyes closed”, and thus more often than not risks spending money and seeing products arrive that fall below his/her expectations.

The dissatisfaction of the consumer inevitably triggers a negative effect of return towards the seller, hence which does not ensure the customer loyalty of the client, rather the seller will have earned bad publicity.

Having considered that online sales above all involves the large-scale retail channel, the purchase modes presently available are totally lacking the trust relationship that, for example, the small store across the street can offer, where the owner knows the purchase habits of his/her clients and adds the missing element of “human” evaluation of the product. Presently, purchasing on the online platform of a large-scale retail channel store is entirely impersonal, limiting, not fully satisfying and in a certain sense misleading.

Numerous inventions have been registered for facilitating online purchases, as in the case of the patent US2021021901. But still today it is difficult for the client to select the right product with certainty, without having to blindly trust the seller.

Object of the present invention is to resolve the abovementioned problems by means of a kit which places the client, who wishes to purchase products from home, in contact with an operator, expert in the field and able to advise the client by means of visual and audio feedback.

### DESCRIPTION OF THE INVENTION

According to the present invention, a kit is attained for assisting with online purchases which effectively resolves the abovementioned problems.

The operator, expert of the field, is equipped with a kit for assisting with purchases which comprises a dynamic visor.

Said dynamic visor allows the operator to view the data and the profile of the client with whom he/she is being connected, clarifying possible preferences and intolerances.

All the obtained data is the result of the selections made by the client in the preceding purchases, and such system allows obtaining a historical record of the client and a complete profile.

Due to said dynamic visor, the operator can learn and understand the requests of the client, establishing a relationship of mutual trust.

A video camera is engaged on said visor and is adapted to carry out a video streaming of that which the operator is watching. In this manner, the client can count on a visual support during the selection of the product and during the pickup by the operator.

In order to obtain even more complete feedback, a microphone is worn by the operator in order to communicate the information relative to the selected product.

An audio headphone is further worn by the operator in order to listen to the requests of the client.

The devices comprised within the kit for assisting with online purchases are power supplied by a portable battery, placed within a common container, wearable on the belt of the operator.

A CPU is instead installed within a container that allows the wearability on the operator and is adapted to receive all the input and output data of the present kit, establishing a connection between the operator and the client interested in purchasing by means of a common Wi-Fi internet connection.

A plurality of cables connect the CPU with the audio headphone, the microphone, the video camera and the dynamic visor but, in one embodiment thereof, a Bluetooth connection makes this connection between the devices wireless.

The conversations that took place between the operator and the client are recorded on an archive which, in one embodiment thereof, consists of an online cloud.

The conversations recorded for security reasons are further stored in a rigid memory device, such as a common memory card.

The present invention can be employed not just for online purchases, but also for conducting professional training courses in which knowledge is passed on relative to manual work, where the visual support is indispensable, even when this is remote learning.

In order for the kit to achieve maximum efficiency, a method is employed for assisting with online purchases which, by respecting a plurality of steps, provides complete assistance.

A registration of the client is requested, inserting the personal data and specifying possible preferences and intolerances.

The selection of the store is carried out by the client when he/she wishes to carry out purchases relative to a particular type of product.

Subsequently, it is necessary to spend a little time waiting one's own turn, so as to be served by an operator of the selected store. In one embodiment thereof, said waiting time can be reduced by making an appointment with the operator.

When the connection with the operator occurs, it is possible to display products present in the selected store and receive feedback of the relevant expert.

The selection of the products occurs based on the sensations transmitted by the operator to the client by means of the kit for assisting with online purchases.

Subsequently, the list of purchases made is summarized, and such purchases are inserted within a virtual cart in order to calculate the total sum to be paid.

The payment occurs by means of credit card.

The delivery of the purchased products can be a home delivery but, in one embodiment thereof, said delivery of the products occurs by means of pick up, by the client, at the sales point.

Finally, the client is asked to leave a review with regard to the service performed by the operator.

Said review will be useful for future clients in the selection of the operator and of the store in which the home purchases are to be carried out.

The advantages offered by the present invention are evident in light of the description set forth up to now and will be even clearer due to the enclosed figures and to the detailed description.

### DESCRIPTION OF THE FIGURES

The invention will be described hereinbelow in at least a preferred embodiment as a non-limiting example with the aid of the enclosed figures, in which:

FIG. 1 shows the plurality of devices that constitute the kit for assisting with online purchase. A dynamic visor 10 is adapted to show the operator the profile of the client with which he/she must interact so as to find out about possible intolerances or preferences. A video camera 11 is engaged on said dynamic visor 10 and is adapted to record and share, in streaming, all that the operator sees. In order to render the communication between the operator and the client quite complete, the present kit comprises at least an audio headphone 12 and a microphone 14 that is easily wearable. A plurality of cables 13 connects the devices. A CPU 15 sends and receives the data of the devices comprised in the kit, by means of a Wi-Fi Internet connection 17. If it is necessary to save the conversations which occur between the operator and the client, a memory device 16 is installed and connected to said CPU 15.

FIG. 2 shows the flow diagram that underlies method, object of the invention, connected with the use of the information collected by the kit in order to assist clients in selecting products to be purchased online.

### DETAILED DESCRIPTION OF THE INVENTION

The present invention will now be illustrated merely as a non-limiting or non-binding example, with reference to the figures which illustrate several embodiments relative to the present inventive concept.

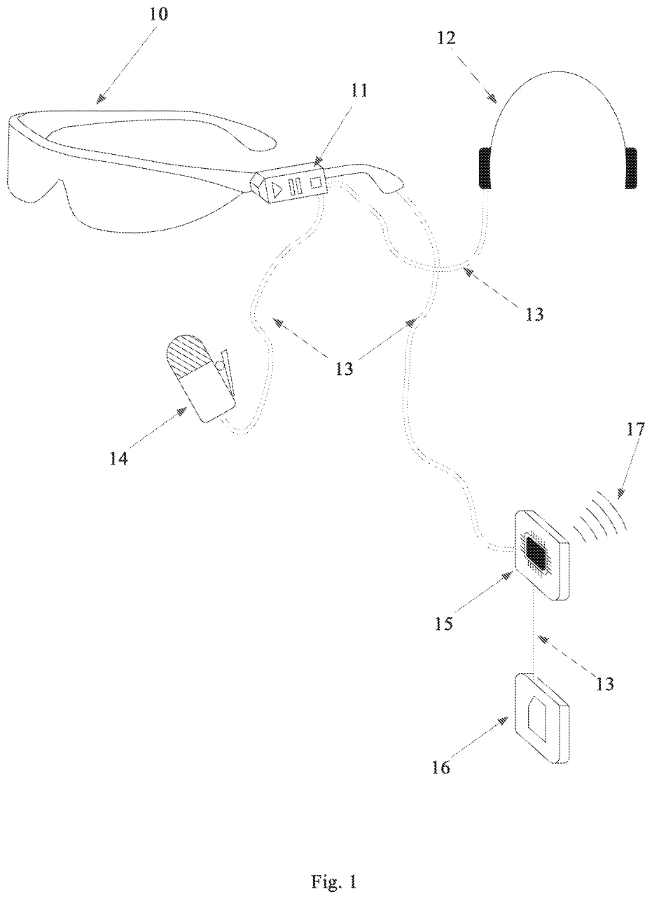

With reference to FIG. 1, the innovative kit for assisting with online purchases is illustrated, which places the operator of the store involved in communication with the client who wishes to make remote purchases.

The operator wears a dynamic visor 10 adapted to allow him/her to view the entire profile of the client, comprising the information with regard to recent purchases and to his/her interests.

Due to the selections made by the client, the visor 10 is adapted to execute a profile of the client, recalling the preferences and possible intolerances.

A video camera 11 is engaged on said visor 10 and is adapted to record, in video format, all that is observed by the operator, in order to present to the client all the products observed by the operator.

A microphone 14 is worn by the operator, due to a clip, and is adapted to record the comments of the operator in order to reply to the questions and curiosities of the client relative to each examined product.

An audio headphone 12 is comprised within the kit and connected by means of a plurality of cables 13. Said audio headphone 12 is adapted to facilitate the communications between the operator and the client during the steps of connection and selection of the products to be purchased.

A CPU 15 is contained within a suitable container, wearable on a belt, and is adapted to send and receive the information to and from the devices that are comprised within the kit for assisting with online purchases.

Said CPU 15 shares the received information due to a Wi-Fi Internet connection 17.

If it is necessary to record and save the conversations that occur between the operator and the client, a memory card 16 is installed at the CPU 15.

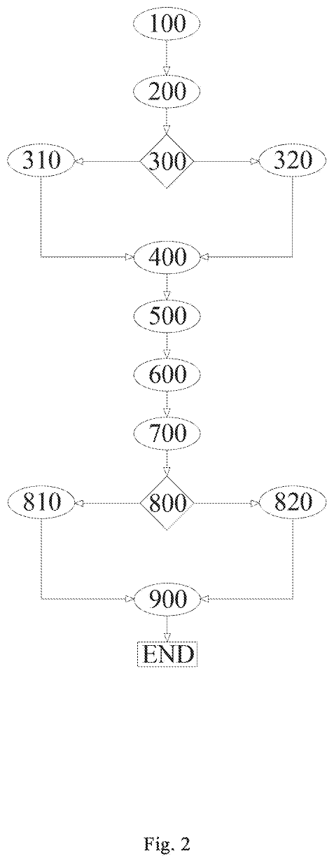

With reference to FIG. 2, the flow diagram is illustrated of the method, which makes use of the kit for assisting with online purchases comprising the steps of:
client registration 100 by inserting the personal data and specifying possible preferences and intolerances;
selection of the store 200 where the client wishes to carry out purchases;
waiting one's own turn 300, so as to be served by an operator;
connection with the operator 400 by means of whom the purchase selections will be carried out with regard to the products present in the store;
selection of the products 500 based on the sensations transmitted by the operator to the client by means of the kit for assisting with online purchases;
summary of purchases carried out 600 and insertion within a virtual cart in order to calculate the total sum to be paid;
payment 700 by means of credit card;
delivery 800 of the goods purchased by the client;
review 900 of the client with regard to the service performed by the operator.

Finally, it is clear that modifications, additions or variations that are obvious to the man skilled in the art can be made to the invention described up to now, without departing from the protective scope that is provided by the enclosed claims.

1. Kit for assisting with online purchases adapted to ensure the display of the products that the client intends to purchase online, by means of a video connection established between the operator and the client; said kit comprising:
at least a dynamic visor, worn by the operator, adapted to allow the display of all the information relative to the preceding selections of the client who is purchasing online;
at least a video camera, engaged on said visor, adapted to share with the client, in video format, all that the operator observes during the online purchase steps;
at least an audio headphone, worn by the operator, adapted to listen to the commands and the preferences of the client during the online purchases;
at least a microphone, worn by the operator, adapted to facilitate the communications between the operator and the client, thus allowing an exchange of information with regard to the characteristics of the product that the client intends to remotely purchase;
at least a portable battery, placed within a common container, wearable on the belt of the operator, adapted to power supply the kit for assisting with online purchases;
at least a CPU, installed within a container which allows the wearability thereof on the operator, adapted to receive all the input and output data of the present kit, establishing the communication between the operator and the client interested in purchasing by means of a common Wi-Fi internet connection;
a plurality of cables, adapted to place in communication all the components comprised within the present kit.

2. The kit for assisting with online purchases, according to claim 1, wherein said visor is adapted to show, to the operator who wears it, the profile of the client with whom he/she is in contact and the possible food intolerances.

3. The kit for assisting with online purchases, according to claim 1, wherein a Bluetooth connection places in communication the dynamic visor, the video camera, the audio headphone, the microphone and the CPU.

4. The kit for assisting with online purchases, according to claim 1, wherein the conversations between the operator and the client are recorded within a common memory device.

5. The kit for assisting with online purchases, according to claim 1, wherein the conversations between the operator and the client are loaded on an online cloud.

6. (canceled)

7. Method for assisting with online purchases comprising:
providing the kit of claim 1;
registering a client by inserting the personal data and specifying possible preferences and intolerances;
selecting a store where the client wishes to carry out purchases;
waiting one's own turn, so as to be served by an operator,
connecting with the operator by means of which purchase selections will be made regarding the products present in the store;
selecting the products based on the sensations transmitted by the operator to the client by means of the kit for assisting with online purchases;
summarizing purchases made and insertion within a virtual shopping cart in order to calculate the total sum to be paid;
making payment by means of credit card;
delivering the goods purchased by the client;
reviewing the client with regard to the service performed by the operator.

8. The method for assisting with online purchases, according to claim 7, wherein the waiting of one's own turn occurs by placing oneself in line, giving priority to the clients who connected themselves previously.

9. The method for assisting with online purchases, according to claim 7, wherein the waiting of one's own turn is reduced by making an appointment with the operator.

10. The method for assisting with online purchases, according to claim 7, wherein the delivery of the purchased goods occurs by means of pick up by the client directly at the sales point involved, at the time established by the client himself/herself.

11. The method for assisting with online purchases, according to the claim 7, wherein the delivery of the purchased goods occurs by means of home delivery to the address provided by the client.

12. The method of claim 7, wherein the method is performed in schools and in professional training courses in order to pass on a prior art and facilitate remote learning.

13. The kit for assisting with online purchases, according to claim 2, wherein a Bluetooth connection places in communication the dynamic visor, the video camera, the audio headphone, the microphone and the CPU.

14. The kit for assisting with online purchases, according to claim 2, wherein the conversations between the operator and the client are recorded within a common memory device.

15. The kit for assisting with online purchases, according to claim 3, wherein the conversations between the operator and the client are recorded within a common memory device.

16. The kit for assisting with online purchases, according to claim 2, wherein the conversations between the operator and the client are loaded on an online cloud.

17. The kit for assisting with online purchases, according to claim 3, wherein the conversations between the operator and the client are loaded on an online cloud.

18. The kit for assisting with online purchases, according to claim 4, wherein the conversations between the operator and the client are loaded on an online cloud.

19. The method for assisting with online purchases, according to claim 8, wherein the delivery of the purchased goods occurs by means of pick up by the client directly at the sales point involved, at the time established by the client himself/herself.

20. The method for assisting with online purchases, according to claim 9, wherein the delivery of the purchased goods occurs by means of pick up by the client directly at the sales point involved, at the time established by the client himself/herself.

21. The method for assisting with online purchases, according to claim 8, wherein the delivery of the purchased goods occurs by means of home delivery to the address provided by the client.
